(19) United States
(12) Patent Application Publication
(10) Pub. No.: US 2022/0197065 A1
(43) Pub. Date: Jun. 23, 2022

(54) Variable Infrared Attenuator With High Precision At High Attenuation

(71) Applicant: Truventic, LLC, Orlando, FL (US)

(72) Inventors: Pedro N. Figueiredo, Ventura, CA (US); Robert E. Peale, Winter Park, FL (US)

(21) Appl. No.: 17/551,356

(22) Filed: Dec. 15, 2021

Related U.S. Application Data
(60) Provisional application No. 63/126,822, filed on Dec. 17, 2020.

(51) Int. Cl. G02F 1/01; G02B 5/04

(52) U.S. Cl. CPC G02F 1/0102; G02F 2203/48; G02B 5/04

(57) ABSTRACT

An infrared attenuator includes a prism having a first conductive element at a surface thereof and a second conductive element at an adjustable distance from the first conductive element. Adjusting the distance controls a degree of infrared absorption by the first conductive element and second conductive element when infrared radiation is incident on the prism to provide variable attenuation.

### CROSS-REFERENCE TO RELATED APPLICATION

This claims the benefit of priority to provisional Application No. 63/126,822, filed Dec. 17, 2020, which is incorporated by reference in its entirety.

### FIELD

This relates to the field of optics and, more particularly, to infrared attenuators.

### BACKGROUND

Fast amplitude modulation of infrared (“IR”) laser intensity has applications in telemetry and infrared scene projection (“IRSP”) among others. A number of variable attenuators for IR lasers are known, including partially-absorbing materials of variable thickness, diffractive metal screens, wire grids, pinholes, variable-angle etalons, and rotating Brewster-angle polarizers.

There are also infrared attenuators that work by exciting surface plasmon polaritons (“SPPs”) on a surface. SPPs are electromagnetic waves that are bound at the interface of a dielectric material and an electrically conductive material. SPP fields are coupled to surface-charge oscillations on the conducting material. Optical excitation of SPPs occurs by slowing the free-space infrared beam to match the SPP momentum.

Excitation of an SPP can be achieved using a prism with an optical beam oriented at an internal angle-of-incidence beyond that for total internal reflection (“TIR”), such that the in-plane wavevector of the associated external evanescent wave equals the SPP wavevector. The energy of the SPP is dissipated by Joule heating due to the excited currents in the conductor. By means of this dissipation of the energy of the excited SPPs, energy from an incident beam of radiation can be permanently removed, resulting in an attenuated reflected beam.

One example of an SPP-based infrared attenuator is an Otto coupler [1]. In an Otto coupler, a prism made from a material that is transparent for the incident beam, and with an index of refraction that exceeds unity, is brought close to, but not in contact with, a conducting surface. When the distance of separation d is optimum, and when the beam's angle of incidence on the internal prism surface near the conductor is at a resonance angle, SPPs are generated on the conductor and the intensity of the internally reflected beam is reduced.

Another example of an SPP-based infrared attenuator is a Kretschmann coupler [2]. A Kretschmann coupler includes an infrared-transparent prism with one face coated by a partially-transparent conducting film. SPPs are excited by an internally reflected beam on the conducting film.

U.S. Pat. No. 10,788,360 discloses an infrared scene generator that uses some of the principles of an Otto coupler to generate an infrared scene. A drawback of this technology is that to achieve the highest attenuation requires precise control of the gap to a challenging degree, and hence precise control of the apparent temperature at high attenuation is difficult.

### BRIEF SUMMARY

It would be advantageous to have an infrared attenuator that permits rapid attenuation adjustment, has a large attenuation range, and has fine control over small intensity differences. For an infrared scene generator, the latter feature may be especially important at large attenuation values. This could be used, for example, to generate IR images having clear contrast for apparent temperature differences as small as a fraction of a degree.

A first example of an infrared attenuator that achieves these objectives includes a prism having a first conductive element at a surface thereof. A second conductive element is at an adjustable distance from the first conductive element. A controller adjusts the distance in such a way that it controls a degree of infrared absorption by the first conductive element and second conductive element when infrared radiation is incident on the prism.

The first example of the infrared attenuator may include one or more of the following additional features.

The first conductive element may be on a surface of the prism.

The first conductive element may be a semiconductor and the second conductive element may be a conventional metal.

The first conductive element may be at least partially transparent to the infrared radiation incident on the prism.

The infrared attenuator may have its maximum reflectivity when the adjustable distance is at a minimum thereof.

The infrared attenuator may further include an infrared scene generator that generates an infrared scene.

The first conductive element may be composed of at least one electrically conductive material having a permittivity whose real part is negative at the wavelength of the infrared radiation incident on the prism and which is at least partially transparent to the infrared radiation incident on the prism.

The infrared absorption may be caused by excitation of surface plasmon polaritons.

The infrared attenuator may have a variable apparent temperature that extends to an order of magnitude higher than an ambient apparent temperature.

A second example of the infrared attenuator includes an infrared emitter that emits a beam of infrared radiation. A prism has a first conductive element at a surface thereof where the first conductive element is at least partially optically transparent to the beam. A second conductive element is at an adjustable distance from the first conductive element and reflects the infrared radiation back toward the first conductive element. A controller adjusts the distance in such a way that it controls a degree of infrared absorption by the first conductive element and second conductive element when the infrared radiation is incident on the prism.

The second example of the infrared attenuator may include one or more of the following additional features.

The first conductive element may be a semiconductor and the second conductive element may be a conventional metal.

The infrared attenuator may have its maximum reflectivity when the adjustable distance is at a minimum thereof.

The infrared attenuator may further include an infrared scene generator that generates an infrared scene.

The first conductive element may be composed of at least one electrically conductive material having a permittivity whose real part is negative at the wavelength of the infrared radiation and which is at least partially transparent to the infrared radiation.

The infrared attenuator may have a variable apparent temperature that extends to an order of magnitude higher than an ambient apparent temperature.

The infrared absorption may be caused by excitation of surface plasmon polaritons.

An example of a method of attenuating a beam of infrared radiation includes emitting the beam onto an infrared attenuator having a prism with a first conductive element at a surface thereof and a second conductive element at a distance from the first conductive element. Adjusting the distance causes infrared absorption by the first conductive element and second conductive element.

The method may include one or more of the following additional features.

The first conductive element may be on a surface of the prism.

The first conductive element may be a semiconductor and the second conductive element may be a conventional metal.

The first conductive element may be at least partially transparent to the infrared radiation.

The infrared attenuator may have its maximum reflectivity when the distance is at a minimum thereof.

The method may further include generating an infrared scene.

The first conductive element may be composed of at least one electrically conductive material having a permittivity whose real part is negative at the wavelength of the infrared radiation incident on the prism and is at least partially transparent to the infrared radiation incident on the prism.

The infrared attenuator may have a variable apparent temperature that extends to an order of magnitude higher than an ambient apparent temperature.

The infrared absorption may be caused by the excitation of surface plasmon polaritons.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1 is a diagram of an example of a variable IR attenuator.

FIG. 2 is a diagram of an example of an IR scene generator that includes the variable IR attenuator.

FIG. 3 is a diagram illustrating an example of a first infrared scene and a second infrared scene.

FIG. 4 is a block diagram illustrating an example of an array of the variable IR attenuators.

FIG. 5 is a block diagram illustrating a different example for an arrangement of the variable IR attenuators.

FIG. 6 is a graph of the SPP resonance angle vs plasma wavelength for different conductors at 5 μm wavelength.

FIG. 7 is a contour plot of reflectance vs internal incidence angle and film thickness for an Aluminum-on-CaF₂-prism Kretschmann coupler.

FIG. 8 is a graph of SPP mode height vs. plasma wavelength.

FIG. 9 is a graph of the Kretschmann coupler reflectance at 5 μm operating wavelength as a function of internal incidence angle for different conductors.

FIG. 10 is a graph of the calculated variable IR attenuator reflectance at SPP resonance with optimized first-conductor thickness as a function of air gap (d).

FIG. 11 is a graph of the calculated variable IR attenuator reflectance at SPP resonance with optimized first-conductor thickness as a function of air gap (d) using semi-logarithmic axes.

FIG. 12 is a graph of the blackbody temperature vs MWIR radiance.

FIG. 13 is a graph of the apparent temperature vs. air gap d for the variable IR attenuator under the indicated conditions.

FIG. 14 is a graph of the measured reflectance of the variable IR attenuator for two gap (d) values.

### DETAILED DESCRIPTION OF EXAMPLE EMBODIMENTS

This describes example aspects and embodiments, but not all possible aspects or embodiments of the variable infrared attenuator and its related methods. Where a particular feature is disclosed in the context of a particular aspect or embodiment, that feature can also be used, to the extent possible, in combination with and/or in the context of other aspects and embodiments. The attenuator and its related methods may be embodied in many different forms and should not be construed as limited to only the examples described here.

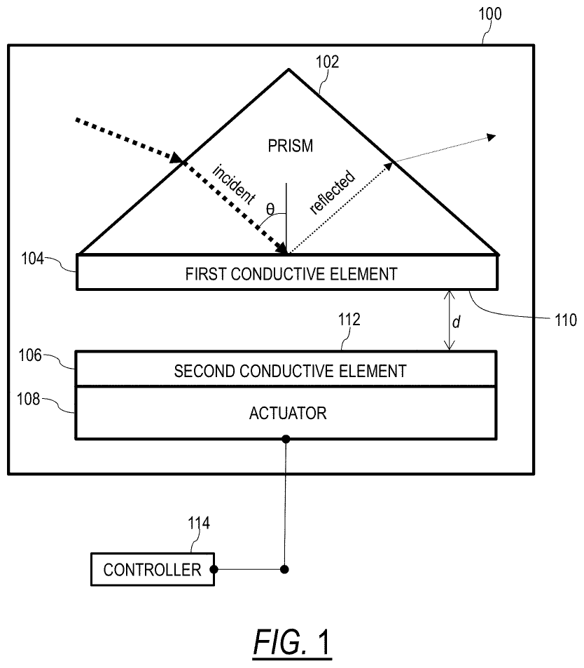

Referring to FIG. 1, an example of the variable IR attenuator 100 includes a prism 102, a first conductive element 104, a second conductive element 106, and an actuator 108. The actuator 108 is operable to adjust the distance d between a bottom surface 110 of the first conductive element 104 and a top surface 112 of the second conductive element 106 based on instructions received from a controller 114.

The distance d is one of the factors that determines the degree to which the incident radiation gets attenuated. When d is large, the incident beam can be strongly absorbed, making the intensity of the reflected beam very weak. When this distance d is decreased, the absorption of the incident beam decreases, and the intensity of the reflected beam increases. Variation of the distance d allows for the intensity of the reflected radiation associated with the attenuator 100 to be adjusted.

The prism 102 may be composed of a material that is substantially transparent to the incident beam and has an index of refraction greater than unity. The prism 102 may have a triangular cross-section or a hemi-cylindrical cross-section in the plane of incidence.

For the mid-wave infrared band (MWIR, 3-5 micron wavelength), the prism 102 may be, for example, composed of Al₂O₃ (sapphire), CaF₂ (calcium fluoride), ZnSe (zinc selenide), Si (silicon), or Ge (germanium). For the long-wave infrared band (LWIR, 8-12 micron wavelength), the latter three materials are suitable, among other possible examples.

The first conductive element 104 may be composed of at least one electrically conductive material, including, for example, metals, semimetals, and semiconductors. The choice depends on the wavelength of the incident beam.

To support an SPP, the first conductive element 104, should be composed of a material having a negative real part of the permittivity ε′<0, and the always-positive imaginary part of the permittivity ε″ should satisfy the condition |ε′|>>ε″>0 at the wavelength of the incident beam. The SPP excitation absorption is maximum at an internal incidence angle θ_{SPP}, which exceeds the internal incidence angle for total internal reflection θ_{TIR}. The angle θ_{SPP} is referred to as the resonance angle. However, if |ε′| is too large, the angles θ_{SPP} and θ_{TIR} are almost equal, and the resonance narrows angularly. An angularly narrow resonance complicates beam alignment and increases the required degree of collimation to achieve maximum absorption and the widest possible range of attenuation. Broad angular resonances occur when θ_{SPP} significantly exceeds θTIR, which requires the smaller negative E′ values that occur when the operating wavelength A is just beyond the plasma wavelength λₚ of first conductive element 104. Here, λₚ is the wavelength at which the real part of the permittivity passes through zero and changes from negative to positive as the operating wavelength decreases.

The first conductive element 104 should be at least semitransparent at the wavelength of the incident beam. This can be achieved by making the first conductive element 104 in the form of a sufficiently thin film or coating, or the like, on the prism 102. The thickness of the first conductive element 104 may be selected based on the material itself and the wavelength of the incident beam.

In certain examples, the first conductive element 104 is a conducting oxide such as Ga-doped ZnO (“GZO”), fluorine-doped tin oxide F:SnO₂ (“FTO”), or the like. In other examples, the first conductive element 104 is an aluminum layer that is thick enough to not be completely oxidized, but thin enough to remain at least partially transparent to the incident radiation.

Semiconductors may, in some examples, be useful for the first conductive element 104 because their resistivity and permittivity spectrum can be adjusted by doping. Doping can cause the real part of the semiconductor's permittivity ε′ to have suitable negative values at the operating wavelength, so that the material will support SPPs with optimal properties for the attenuation application at the beam's wavelength. For example, in the LWIR, the first conductive element 104 might be a layer of heavily-doped Si deposited on a transparent ZnSe prism. As another example, a Si prism might be used, and the first conductive element 104 created by ion-implanting one surface with dopants such as B (boron) or P (phosphorus).

An important consideration for the selection of the material for first conductive element 104 is that the real part of that material's permittivity should be negative at the wavelength of the infrared beam incident on the prism 102. There may be numerous secondary considerations, such as, for example, compatibility with the prism 102 material, availability of a suitable method of deposition, the smoothness of the resulting surface 110, stability in the operating environment, and cost.

The first conductive element 104 material may be formed directly on the surface of the prism 102. In some examples, it may further include an additional thin layer of material on the surface of the prism 102 to help adhere the first conductive element 104 to the prism 102.

The second conductive element 106 may be selected to maximize the reflectivity when the distance d goes to zero. The second conductive element 106 may be selected from among many different electrically conductive materials including metals, semimetals, and semiconductors based on the wavelength of the incident beam. When the distance d is sufficiently small, the SPP will be shared between the first conductive element 104 and the second conductive element 106. That is, for small d, the device 100 becomes a hybrid between Otto and Kretschmann couplers. To achieve the intended function of high reflectance at zero gap d, the optical and SPP losses in the second conductive element 106 should be small and the second conductive element 106 should be optically thick.

The second conductive element 106 functions as an optical mirror at the wavelength of the incident radiation. Conventional metals such as aluminum, gold, copper, and silver, among other possibilities are used as the second conductive element 106 in certain examples. The second conductive element 106 should be highly reflecting, which requires low transmittance at the wavelength of the incident radiation. Therefore, the thickness of the film forming the second conductive element 106 is, in most typical cases, thicker than the thickness of the film forming the first conductive element 104.

It should be understood that this disclosure refers to the mechanism of infrared absorption as being based on the creation of surface plasmon polaritons, but others may refer to the absorption mechanism as infrared surface waves or Sommerfeld waves, among other possibilities. Regardless of what the absorption mechanism is technically called, the important feature is that the attenuator 100 can absorb infrared radiation and the degree of absorption depends on the distance d.

In a particular example of the variable IR attenuator, the incident beam is from an IR emitter, such as a laser or the like. Monochromatic or nearly monochromatic IR, with a wavelength of from about 1 μm to about 1000 μm, is advantageous in many IR imaging situations.

In a particular example, the incident beam is as collimated and monochromatic as is practical for a given application. It is to be understood, however, that infrared emitters may not always be capable of producing a purely monochromatic beam. Accordingly, this term “monochromatic” can include wavelengths that slightly deviate around a primary emitted wavelength of the IR emitter.

Examples of IR emitters may include, but are not limited to quantum cascade lasers, blackbody sources with narrow-band-pass spectral filters, metasurface based emitters, light emitting diodes, gas-based lasers, chemical lasers, and discharge plasmas.

Many IR emitters are not capable of emitting radiation over the entire IR spectrum. Thus, different infrared emitters that emit over different wavelengths may be used to cover different regions of the IR spectrum.

Additionally, since SPPs are excited with a beam that is polarized with its electric field in the plane of incidence, known as p-polarized or transverse magnetic, the beam may often be p-polarized to achieve the highest range of attenuation. Many IR emitters are inherently polarized. However, if the emitter is not polarized, it may be polarized using a polarizing filter.

The controller 114 may be a computer or the like having non-transitory computer memory and at least one computer processor capable of carrying out program instructions stored on the memory. The controller 114 is in operable communication with attenuator 100 via conventional wiring or via wireless communication mechanisms. The controller 114 is operable to adjust the distance d by instructing the actuator 108 to move. The distance d can be adjusted to modulate the intensity of the beam that is internally reflected from the surface of prism 102.

The actuator 108 is a mechanical device connected to the second conductive element 106 in such a way that the actuator 108 moves the second electrically conductive element 106 to adjust the distance d. In certain examples the degree of adjustment may be on the order of several micrometers. In order to achieve such sensitive adjustment capability, the actuator 108 may include a microelectromechanical system or “MEMS” device.

One example of a MEMS-based actuator includes a cantilever, whose vertical displacement is controlled by electrostatic repulsion against an elastic restoring force. Another example of a MEMS-based actuator is thermomechanically-controlled. Another example of a MEMS-based actuator is piezoelectrically controlled.

The range of displacement of the actuator(s) 108 can vary depending on the application. In a typical example the displacement may be from about 10 nm to 1 μm, 10 nm to 500 nm, 10 nm to 250 nm, 10 nm to 100 nm, 25 nm to 500 nm, 25 nm to 250 nm, or 25 nm to 100 nm, etc.

One of the advantages of the attenuator 100, compared to conventional IR attenuators and the attenuator described in U.S. Pat. No. 10,788,360 is that the attenuator 100 has high precision at high attenuation. Considering the default state to be one for large d values, when the attenuator 100 functions like a Kretschmann coupler, the attenuator 100 has its highest attenuation in the default state. The attenuation decreases only very slowly as d is decreased from the initial default state, enabling precise control at high attenuation. For the infrared scene generator application, this means that the apparent temperature near ambient temperature can be controlled within small fractions of a degree. This is one of the requirements for infrared scene generators, because they are used to test infrared imagers that need to distinguish objects with only slight differences in apparent temperature near ambient temperature.

Thus, near the default state, a manageable and controllable change in d can result a very fine change of attenuation. In the examples section, it is shown that for a particular attenuator 100, displacing d by a manageable and controllable amount of 100 nm gives an apparent temperature change of just 0.3 K near 300 K. Additionally, the same attenuator 100 has sufficient range of attenuation to reach an apparent temperature over 2000 K as d approaches zero. Conventional IR attenuators cannot achieve a comparably large range of attenuation to realize a comparable range of apparent temperature. Conventional IR emitters cannot achieve such a wide range of apparent or actual temperatures on their own. The finer the control of d, the higher the effective temperature resolution of the attenuator 100.

An example of how to determine apparent temperature of the illuminated variable attenuator will now be described. A blackbody at a given actual temperature has a distinct value of radiance N determined by the Planck function. Radiance is the total energy flux (energy per unit time) contained in the electromagnetic waves emitted per unit area of blackbody surface per unit steradian of solid angle that these waves are emitted into. Band radiance is the radiance that is contained within certain wavelength limits. An object that has the same band radiance as a blackbody at a given temperature, where the band is determined by the limits of a detector's responsivity, is said to have an apparent (to the detector) temperature equal to the actual temperature of that blackbody. The attenuator 100 ideally is illuminated by a plane wave, which has no divergence. After reflecting from the attenuator 100, which has a finite dimension, the beam diverges into a solid angle given in steradians by the square of the ratio of wavelength to the dimension. The reflected power divided by the area of the attenuator 100 divided by the divergence solid angle is the radiance of the attenuator 100. By adjusting the distance d, the reflectance, the radiance, and hence the apparent temperature of the attenuator 100 are changed.

In a particular example of the variable attenuator 100, the attenuator 100 has a variable apparent temperature that extends to an order of magnitude higher than an ambient apparent temperature. The “ambient apparent temperature” is the apparent temperature of the environment at its equilibrium temperature. As a particular example, the environment might be a location on the surface of Earth at an equilibrium temperature of 300 K. As a second particular example, the environment might be space at an apparent temperature of 100 K. For the sake of clarity, an apparent temperature that is “an order of magnitude” above ambient apparent temperature may be broadly defined to include any value from about 5 times the ambient apparent temperature to about 50 times the ambient apparent temperature.

The IR attenuator 100 may be used in any situation where IR attenuation is desired, such as in optics devices, IR measurement devices, telemetry, and others. One example of an application where it is particularly useful is in infrared scene generation. This is due to its achievable wide range of apparent temperature and its high apparent-temperature resolution near ambient apparent temperature. An IR scene generator including a plurality of the attenuators 100 will now be described.

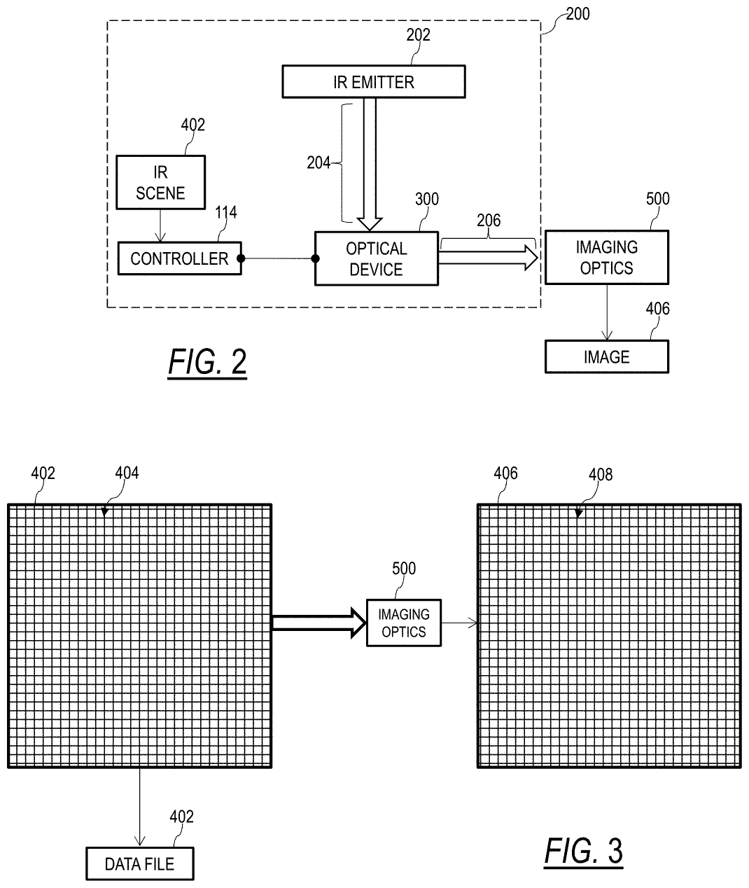

Referring to FIG. 2 an example of an infrared scene generator 200 includes an infrared emitter 202 emitting a beam 204 of infrared radiation, which is incident on an optical device 300. The optical device 300 modulates the incident beam 204 intensity to produce a spatially modulated beam 206. The spatial modulation includes variations in the intensity in a 2D cross section of beam 204 in a plane perpendicular to its propagation direction.

Referring now to FIG. 3 as well as FIG. 2, the controller 114 in communication with the optical device 300 stores a 2D array of values representing the infrared intensity variations in a first infrared scene 402 to be emulated in the modulated beam 206 by the optical device 300. The controller 114 is operable to control the optical device 300 in such a way that the modulated beam 206, when projected onto a focal plane by suitable imaging optics 500, produces an image, or second infrared scene 406, representative of the first infrared scene 402. A user of the infrared scene generator 200 can provide imaging optics 500 to produce the image 406, which may be detected using a focal plane array infrared detector, for example.

The first infrared scene 402 may include a set of intensity values for infrared radiation emitted or reflected by actual, real-world objects. The first infrared scene 402 may, in the alternative, be a simulated or computer-generated scene. The first infrared scene 402 may include, for example, military targets such as missiles, aircraft, vehicles, or personnel. The first infrared scene 402 may change with time, so that a series of first infrared scenes may be recorded or generated to produce a video of a scene.

The first infrared scene 402 is a reference scene that has been previously electronically recorded. The scene may be a still image, series of still images, a video, or the like. The first infrared scene 402 includes an array of numerical values that represent the infrared intensity emitted or reflected by sub-areas of an actual or simulated scene known as picture elements (pixels) 404. The infrared intensity value corresponds to the intensity of the infrared signal recorded for the corresponding spatial location of each pixel. There are many ways to represent the infrared intensity values, including by intensity, radiance, and source apparent temperature among others.

In many cases, infrared images are color-coded so that a particular color corresponds to a particular apparent temperature or other measure of infrared intensity. In such cases, the infrared intensity values may correspond with the color of each individual pixel in the scene.

The right panel of FIG. 3 is an illustration of the modulated beam 206 projected by imaging optics 500 onto a focal plane to produce an image or second infrared scene 406. In a particular example, discrete spatial locations 408 in the image 406 corresponding to the spatial locations 404 of pixels in the first infrared scene 402 may be assigned an apparent temperature to emulate a real-world infrared image.

After the incident beam 204 is reflected by the optical device 300, the reflected beam associated with each conductive element will spread, so that the spatial intensity distributions of the different sub-beams will spatially overlap. A simple cross section of the modulated beam 206 will not contain a clear subdivision of intensity values corresponding to those in the pixels of the first infrared scene 402. The imaging optics 500, however, are operable to produce the second infrared scene 406 from the modulated beam 206, where the spatial intensity variations are so subdivided.

Figures of merit for IR scene generators include maximum radiant intensity, dynamic range, and grayscale resolution. These can be quantified in terms of apparent temperature of the scene. Higher apparent temperature requires higher intensity at the detection system. High dynamic range of apparent temperature requires that the intensity be variable over many orders of magnitude. High grayscale resolution means that the least significant bit of control voltage change should give a small change in apparent temperature.

The infrared intensity values of a given scene may be tabulated based on the intensity value and the location in two-dimensional space of each pixel in the scene. When stored on the controller 114, the controller 114 uses the infrared intensity values to control the degree to which the incident beam 204 is modulated by the optical device 300 at different positions within the optical device 300 corresponding to the pixel locations in the first infrared scene 402.

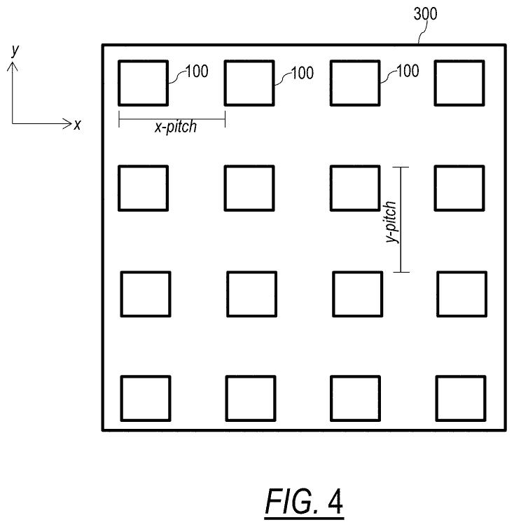

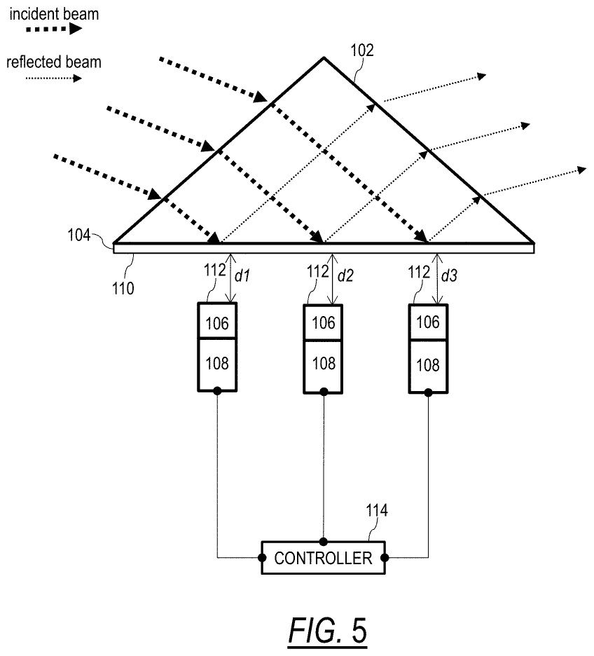

Additional details of the optical device 300 are now described with reference to FIGS. 4-5.

The optical device 300 functions as a spatial infrared-radiation modulator based on variable reflection from an array of the variable IR attenuators 100. The incident beam interacts with the surfaces of the first conductive element 104 and second conductive element 106 of the attenuators 100. The intensity of the incident beam is variably modulated at each attenuator 100 in the array by excitation of SPPs as discussed above.

Referring to FIG. 4, an example of the optical device 300 includes a plurality of attenuators 100 arranged in a two-dimensional grid pattern, or array, in x and y directions. Each attenuator 100 is placed generally in a periodic array with period, or pitch, which may be different in x and y directions. The number of attenuators 100 determine the spatial resolution of the image 406 that can be produced. For a given number of attenuators 100, the pitch determines the overall dimensions of the optical device 300. The pitch may vary depending on the desired application and wavelength of the beam 204, among other factors. In a particular example, the x-pitch and the y-pitch are about 50 μm.

The example of FIG. 4 shows a 4 by 4 array of attenuators 100 for ease of illustration. The array may include any number of attenuators, depending on the desired spatial resolution for the image 406 and is not necessarily limited to any particular number or arrangement of attenuators.

A second example of an arrangement for the attenuators 100 for an IR scene generator is depicted in FIG. 5. In this arrangement, one prism 102 is coupled with a plurality of second conductive elements 106 and actuators 108. Each actuator 108 can independently adjust the distance d1, d2, d3 between the top surface 112 of the respective second conductive element 106 and bottom surface 110 of the first conductive element 104 for each pixel.

To be representative of the first infrared scene 402, the second infrared scene 406 may be a substantially exact reproduction of the first infrared scene 402, but this is not necessarily always the case. If the first infrared scene 402 has a higher spatial resolution than the optical device 300 can produce, the second infrared scene 406 will be a lower-resolution approximation of the first infrared scene 402. Further, the second infrared scene 406 need not always appear in the same color scale as the first infrared scene 402. To be representative of the first infrared scene 402 all that is needed is for the second infrared scene 406 to be a close enough reproduction of the first infrared scene 402 to simulate the first infrared scene 402.

The optical device 300 may be calibrated so that a specified degree of modulation from each attenuator 100 corresponds to a particular infrared intensity value, represented by an apparent temperature. In this manner the controller 114 can determine how much to adjust the distance d to achieve the desired infrared intensity value from the individual attenuators 100 so that the modulated beam 206 can produce the second infrared scene 406 representative of the first infrared scene 402.

### EXAMPLES

This section describes example features of the actuator 100 in more detail. The details described here are for illustration purposes only and do not limit the scope of possible features or example embodiments.

The momentum-matching condition for exciting SPPs with the attenuator 100 is

$${n}_{p} sin {θ}_{SPP} = Re \sqrt{\frac{{ɛ}_{c} ( ω )}{{ɛ}_{c} ( ω ) + 1}} , \qquad ( 1 )$$

where ε_{c} is the complex frequency-dependent permittivity of the first conductive element 104 and nₚ the prism's refractive index. Equation (1) resembles the condition for total internal reflection (TIR), namely

nₚ sin θ_{TIR}=1 (2)

The SPP fields decay exponentially away from the surface with a characteristic length L given by

$$\frac{1}{L} = ( \frac{2 π}{λ} ) Re \sqrt{\frac{- 1}{{ɛ}_{c} + 1}} . \qquad ( 3 )$$

The SPP resonance condition Eq. (1) tells nothing about the resonance strength or angular line shape. However, these are accurately calculated using Fresnel equations for a multi-layer system.

The calculations assume Al, GZO, or FTO as the first conductive element. GZO is Ga-doped ZnO, which is a conducting-oxide that can be deposited by pulsed-laser deposition or sputtering. The complex permittivity spectrum of GZO, and excitation of IR SPPs on GZO, have been reported as a function of resistivity [3].

FTO stands for fluorine-doped tin oxide, which can be deposited by an aqueous spray method. The complex permittivity of FTO, and excitation of IR SPPs on FTO, have also been reported as a function of doping and growth conditions [4,5].

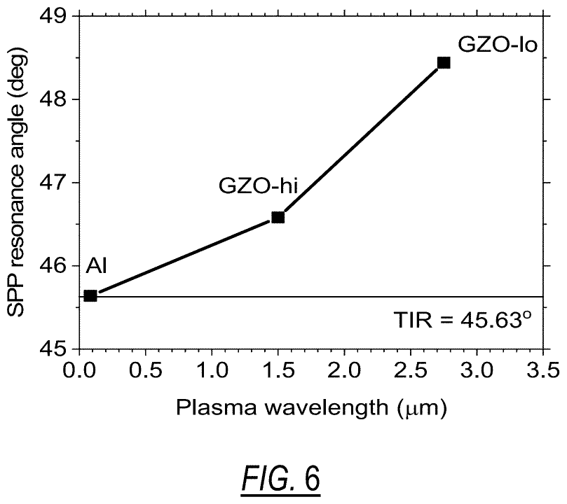

The effect on the angular position and line shape of the SPP excitation resonance as a function of plasma wavelength for specific conductors was first investigated. The calculated resonance angle vs. plasma wavelength is presented in FIG. 6. It was assumed the prism is CaF₂, having refractive index of 1.39896 at the assumed operating wavelength of 5 μm. The horizontal line labeled (TIR) in FIG. 6 indicates the 45.63° critical angle for total internal reflection. The symbols in FIG. 6 represent SPP resonance angles calculated from Equation (1) for two films of PLD GZO, labeled GZO-hi and GZO-lo for high and low conductivities, respectively [3]. The angles for the considered conductors are plotted as a function of their plasma wavelengths. All of the resonance angles are beyond the critical angle, as expected. The resonance angles increase as the plasma wavelength increases toward the operating wavelength. The farther beyond TIR that the resonance angle occurs, the easier would be the optical alignment.

Equation 1 holds for optically thick metals. However, for SPPs to be excited using a Kretschmann-like coupler, which the attenuator 100 becomes for large d, the conducting film on the prism should be sufficiently thin as to be at least semitransparent at the excitation wavelength. To investigate the effect of the thickness of the first conductive element 104, Fresnel calculations were performed for an Aluminum film on a CaF₂ prism.

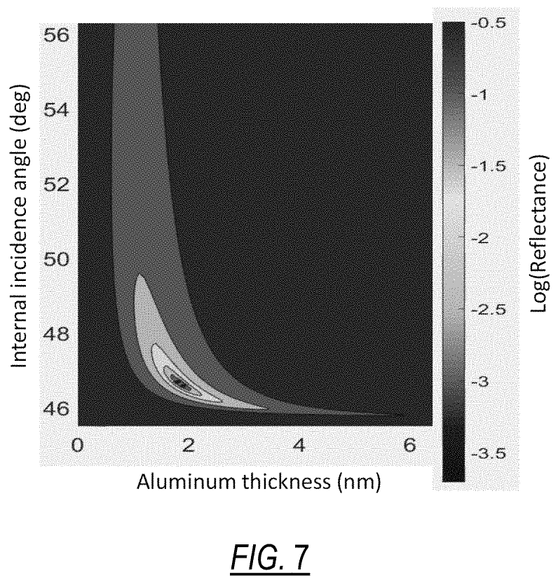

FIG. 7 presents a contour plot of calculated log reflectance vs internal incidence angle and first conductive element thickness at 5 μm wavelength. The resonance occurs at the angle calculated from Equation 1 only for Al thickness greater than 5 nm. The skin depth of Al at 5 μm wavelength is 10 nm. However, the resonance depth goes to zero in this limit. For thinner Al films the resonance angularly broadens and shifts to larger angle. The minimum reflectance occurs at a thickness of 1.8 nm. The calculations assume that the thin film is homogeneous with the optical properties of bulk Al. FIG. 7 shows that the actual resonance angles will be larger than those predicted by Equation 1 for film thicknesses that optimize the absorption.

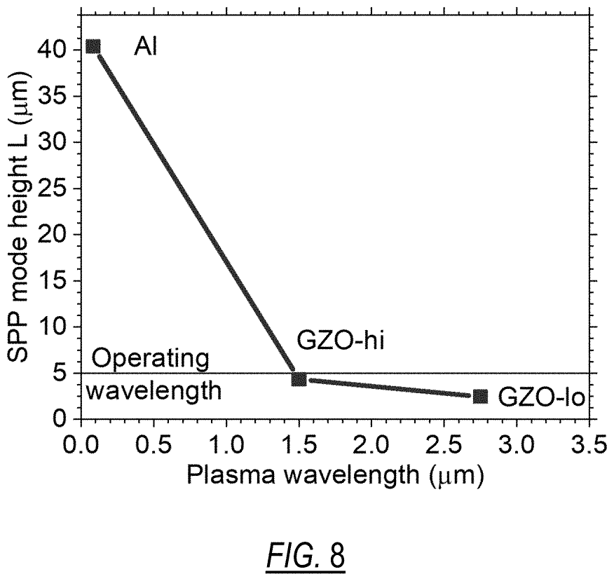

FIG. 8 presents the SPP mode height L as a function of plasma wavelength for the same three conductors as in FIG. 6. The L values were calculated from Equation 3 assuming optical constants for optically-thick conductors. The horizontal line indicates the mode height that equals the 5 μm operating wavelength. The SPP tends to become more confined as the plasma wavelength of the conductor increases toward the operating wavelength. For Al, the L value is 8 times larger than the operating wavelength. For the highly doped GZO, L is about the same as the wavelength. For the low-doped GZO, L is about half the wavelength.

For a pure Otto coupler, the SPP mode height defines the gap value required for optimal SPP excitation and maximum attenuation. However, for the variable infrared attenuator 100, which is a hybrid of Otto and Kretschmann couplers, the SPP can be shared [6] between the two conductive elements 104, 106 with different permittivity spectra. Then the relationship between L, d, and attenuation is less simple.

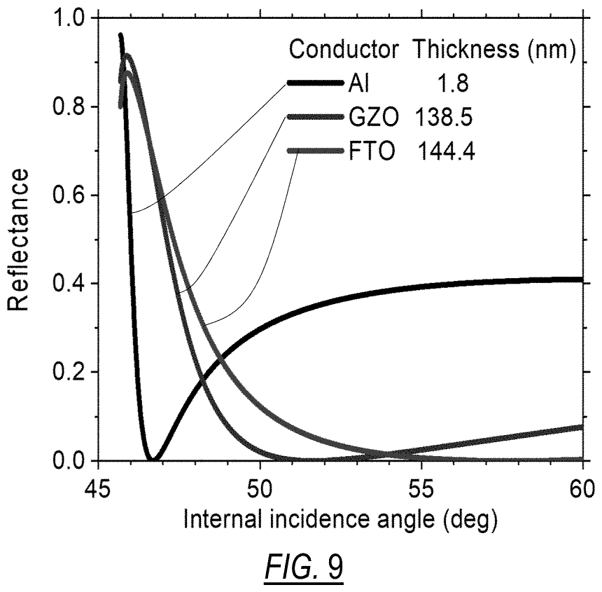

FIG. 9 presents Fresnel-calculated IR reflectance vs. incidence angle for Kretschmann couplers with optimum-thicknesses (indicated) of aluminum or two example conducting oxides. The latter are sputtered 0.6 mOhm-cm GZO and 10% FTO [5]. The permittivity values used in the calculations at 5 μm wavelength, as determined by IR ellipsometry, were −12.9877+i 10.8288 and −7.2695+i 12.6857, respectively. The calculated angular resonance spectra are the same as would be expected for the variable infrared attenuator 100 with large gap d.

The resonant absorption in FIG. 9 is nearly 100% for all three materials. For Al, whose λₚ<<<λ, the resonance occurs closest to the 45.6° TIR angle and the resonance is relatively sharp, in agreement with the contour plot FIG. 7. However, for the 1.8 nm optimum thickness, the Al film would probably be inhomogeneous and oxidized, in practice. As λₚ approaches A for GZO and FTO, the resonance becomes angularly broad, which would facilitate optical alignment. Moreover, the absorption is ˜10000× stronger than for Al (as will be shown), the thicknesses suffice for good uniformity, and these oxide films are chemically-stable in air. For all three materials, the calculated reflectance decreases at angles below TIR due to transmission loss.

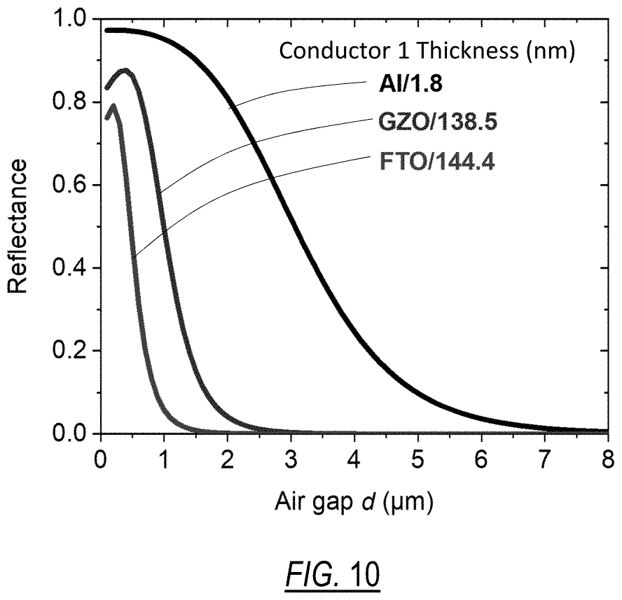

The second conductive element 106 should be a good metal with low optical and SPP losses to maximize reflectivity when the gap d goes to zero. Aluminum was chosen for the second conductive element 106 in the calculations and experiments described next. FIG. 10 presents calculated reflectance at SPP resonance vs air gap for a particular example of the variable attenuator. The thicknesses considered for the first conductive element 104 are given in FIG. 10 and are optimized for minimum reflectance at the 5 μm operating wavelength. When λₚ<<<λ, as for Al, the reflectance approaches zero only for gaps of at least 8 μm, and the gap must be tuned by ˜6 μm to achieve the full range of reflectance. When λₚ approaches λ, as for FTO, R goes to zero already by 2 μm gap, and most of the variation in reflectance occurs over a gap range of ˜1 μm. These smaller displacements would be much more convenient for control by a (e.g.) microelectromechanical systems (MEMS) actuator. The reflectance does not approach unity until the gaps are significantly smaller than the calculated mode heights, because the SPP can still be excited and shared between both conductors for d<L.

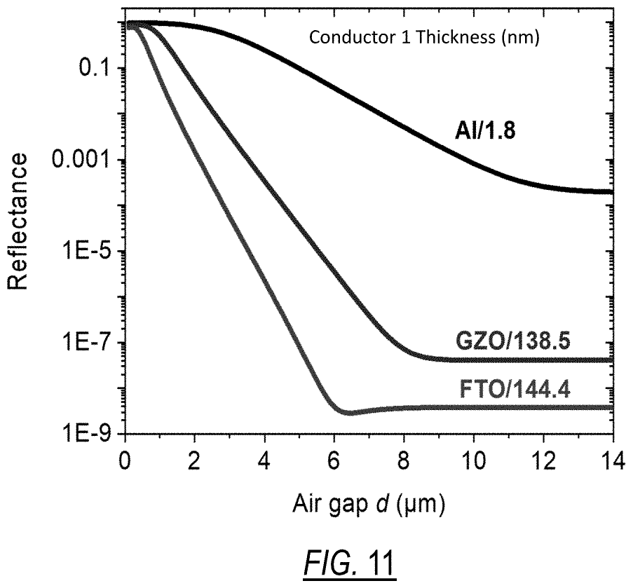

FIG. 11 presents the same data as in FIG. 10, but with a logarithmic reflectance axis. This shows that R decreases with increasing gap d to a minimum that corresponds to the Kretschmann configuration, beyond which R stops changing. For intermediate gaps d, R changes exponentially with gap by 0.4, 1, and 1.5 decades per μm for Al, GZO, and FTO, respectively. The reflectance for FTO changes by more than eight orders of magnitude, and the minimum reflectance is more than 10000× smaller than for Al.

An IR scene generator incudes an array of pixels as described above. A plane wave incident on such a pixel has a finite divergence after reflection due to the finite pixel area. If the wavelength is λ and the pixel pitch is p, the divergence solid angle Ω=(λ/p)². If illumination occurs using a collimated source or plane wave of a given intensity I in Watts per square meter, then the unattenuated radiance of a pixel would be I/Ω in Watts per square meter-steradian.

IR scene generators are used for testing imaging systems, which are usually designed for specific IR bands, such as the MWIR (3-5 μm wavelength) band, with ideally no response outside the band. The dynamic range of an IR scene generator is often defined in terms of the temperature of a blackbody source, whose temperature is related to radiance by the Planck function.

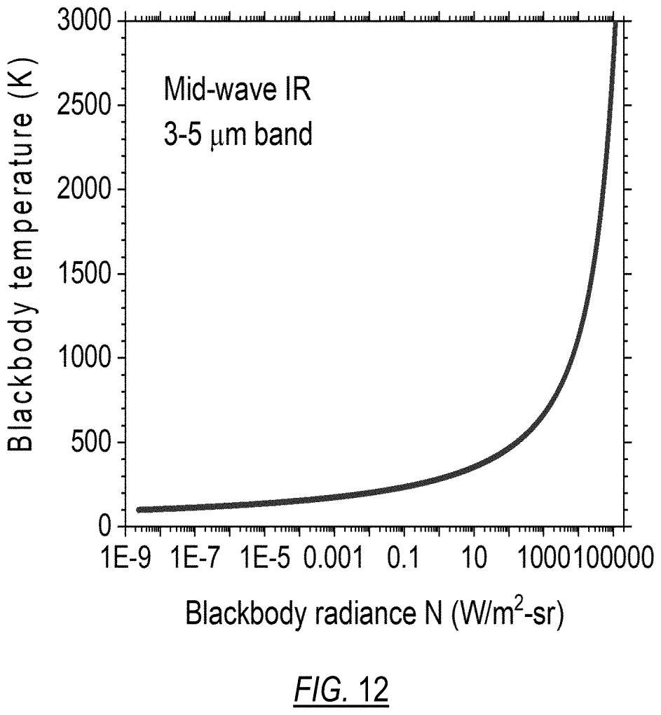

FIG. 12 presents a plot of blackbody temperature as a function of the calculated radiance within the MWIR 3-5 μm band. With curves such as FIGS. 11 and 12, an infrared scene generator may be designed based on the variable infrared attenuator 100 for any temperature range of interest. It is advantageous to choose the intensity of the illumination source so that the lowest apparent scene temperature is achieved in the default state of large d, maximum attenuation, and minimum reflectance. Then the first conductive element 104 is chosen so that the maximum desired apparent temperature can be reached before the maximum reflectance is reached at d=0.

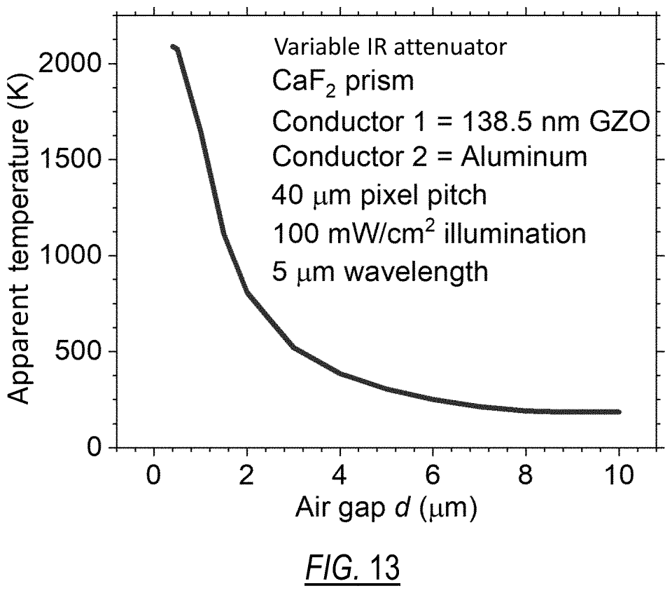

As a particular example, suppose a reasonable value for the collimated incident laser intensity of 100 mW/cm² at 5 μm wavelength. Also assume that the first conductive element 104 is GZO as in FIG. 11, with a minimum reflectance of 4.18×10⁻⁸ and a maximum reflectance of 0.83. Further assume a pixel pitch of 40 μm, giving a solid angle of beam divergence after reflection of Ω=0.0156 sr. Then the minimum radiance would be 2.68×10⁻³ W/m²−sr, and the maximum would be 5.32×10⁴ W/m²−sr. According to FIG. 12, these values equal the MWIR radiances at apparent temperatures of 185 and 2039 K, respectively. FIG. 13 presents a plot of apparent temperature vs. air gap d for the variable IR attenuator with the parameters indicated.

A promising feature for infrared scene generation, which is demonstrated by FIG. 13, is that low-apparent temperatures change only slowly with gap d. At 10 μm gap, the effective temperature rises with decreasing gap by only 3K/μm. If one can control the gap d to within 100 nm, the temperature resolution would be 0.3 K, which is about the temperature resolution required of MWIR imagers for scenes near ambient temperature. Finer resolution can be achieved by working at larger gaps d or controlling the gap d more precisely.

A second promising feature is that for rays that impinge on the spaces between pixels such as depicted in FIG. 5, the attenuator 100 functions like a pure Kretschmann coupler with maximum absorption. This means there is substantially no source of glare from those regions of the prism 102.

The range of apparent temperatures demonstrated by FIG. 13 is 185-2089 K. The higher temperature is approximately the temperature of the tailpipe of a ramjet, which has significance for testing of military seeker technology. A shift in the range upward to 300-3000 K might be desirable because it would cover room temperature up to the temperature of combustion in kerosene-oxygen rocket motors, for example.

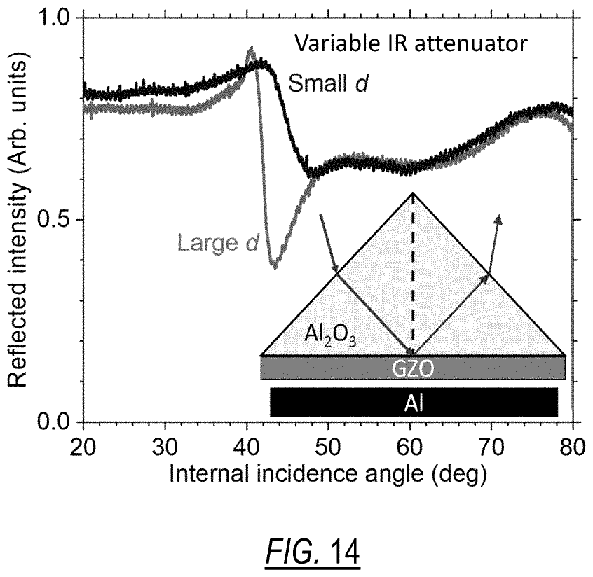

Results of variable IR attenuator experiments are presented in FIG. 14. They were performed using a sapphire prism coated with the first conductive element 104, which was a transparent conducting oxide Gallium-doped Zinc Oxide (GZO) separated from an Al mirror, as the second conductive element 106 by a thin layer of air. The GZO was deposited on the prism by sputtering. The GZO resistivity was measured to have the same 0.6 mΩ-cm value as used in the calculations. The measured GZO thickness of 195 nm exceeded the optimum value 152 nm value determined by calculation. Radiation with 4.5 μm wavelength and p-polarization from a Quantum Cascade Laser (QCL) was collimated by an off-axis parabolic mirror. The specularly reflected beam was detected using a goniometer and a 77 K mercury cadmium telluride (MCT) detector.

The different values of d were obtained by varying the pressure between the second conductive element 106 and the prism. The curve labeled “large d” shows the expected SPP resonance. The curve labeled “small d” corresponds to a gap that is sufficiently small to quench the SPP creation on the first conductive element 104, which increases the reflectance twofold. Though the experimental apparatus and GZO thickness were unoptimized, this experiment demonstrates the principle of variable IR reflectance using the variable infrared attenuator 100.

The variable IR attenuator 100 has potentially high dynamic range, high precision control at high attenuation, and potentially high modulation speed. The configuration facilitates fine control at attenuation values of order 10 million for a GZO first conductive element 104, and over 100 million for FTO, according to FIG. 11.

The skilled person in the art will understand that the variable IR attenuator, scene generator, and related methods may be modified in many different ways without departing from the scope of what is claimed. The scope of the claims is not limited to only the particular features and examples described above.

### REFERENCES

1. A. Otto, “Excitation of Nonradiative Surface Plasma Waves in Silver by Method of Frustrated Total Reflection,” Z. Phys. 216, 398 (1968).
2. E. Kretschmann, “Die Bestimmung optischer Konstanten von Metallen durch Anregung von Oberflachenplasmaschwingungen,” Z. Phys. 241, 313 (1971).
3. R. Gibson, S. Vangala, I. O. Oladeji, E. Smith, F. Khalilzadeh-Rezaie, K. Leedy, R. E. Peale, and J. W. Cleary, “Conformal spray-deposited fluorine-doped tin oxide for mid- and long-wave infrared plasmonics,” Optical Materials Express 7, 2477 (2017).
4. F. Khalilzadeh-Rezaie, I. O. Oladeji, J. W. Cleary, N. Nader, J. Nath, I. Rezadad, and R. E. Peale, “Fluorine-doped tin oxides for mid-infrared plasmonics,” Optical Materials Express 5, 2184 (2015).
5. R. E. Peale, E. Smith, H. Abouelkhair, I. O. Oladeji, S. Vangala, T. Cooper, G. Grzybowski, F. Khalilzadeh-Rezaie, J. W. Cleary, “Electrodynamic properties of aqueous spray deposited SnO₂:F films for infrared plasmonics,” Opt. Eng. 56, 037109 (2017).
6. R. E. Peale, E, Smith, C. W. Smith, F. Khalilzadeh-Rezaie, M. Ishigami, N. Nader, S. Vangala, and J. W. Cleary, “Electronic detection of surface plasmon polaritons by metal-oxide-silicon capacitor,” APL Photonics 1, 066103 (2016).

That which is claimed is:

1. An infrared attenuator comprising:
a prism having a first conductive element at a surface thereof;
a second conductive element at an adjustable distance from the first conductive element; and
a controller that adjusts the distance in such a way that adjusting the distance controls a degree of infrared absorption by the first conductive element and second conductive element when infrared radiation is incident on the prism.

2. The infrared attenuator of claim 1, wherein the first conductive element is on a surface of the prism.

3. The infrared attenuator of claim 1, wherein the first conductive element is a semiconductor and the second conductive element is a conventional metal.

4. The infrared attenuator of claim 1, wherein the first conductive element is at least partially transparent to the infrared radiation incident on the prism.

5. The infrared attenuator of claim 1, wherein the infrared attenuator has its maximum reflectivity when the adjustable distance is at a minimum thereof.

6. The infrared attenuator of claim 1, further comprising an infrared scene generator that generates an infrared scene.

7. The infrared attenuator of claim 1, wherein the first conductive element is composed of at least one electrically conductive material having a permittivity whose real part is negative at the wavelength of the infrared radiation incident on the prism and which is at least partially transparent to the infrared radiation incident on the prism.

8. The infrared attenuator of claim 1, wherein the infrared absorption is caused by excitation of surface plasmon polaritons.

9. The infrared attenuator of claim 1, having a variable apparent temperature that extends to an order of magnitude higher than an ambient apparent temperature.

10. An infrared attenuator comprising:
an infrared emitter that emits a beam of infrared radiation;
a prism having a first conductive element at a surface thereof, the first conductive element being at least partially optically transparent to the beam;
a second conductive element at an adjustable distance from the first conductive element, the second conductive element reflecting the infrared radiation back toward the first conductive element;
a controller that adjusts the distance in such a way that adjusting the distance controls a degree of infrared absorption by the first conductive element and second conductive element when the infrared radiation is incident on the prism.

11. The infrared attenuator of claim 10, wherein the first conductive element is a semiconductor and the second conductive element is a conventional metal.

12. The infrared attenuator of claim 10, wherein the infrared attenuator has its maximum reflectivity when the adjustable distance is at a minimum thereof.

13. The infrared attenuator of claim 10, further comprising an infrared scene generator that generates an infrared scene.

14. The infrared attenuator of claim 10, wherein the first conductive element is composed of at least one electrically conductive material having a permittivity whose real part is negative at the wavelength of the infrared radiation and which is at least partially transparent to the infrared radiation.

15. The infrared attenuator of claim 10, having a variable apparent temperature that extends to an order of magnitude higher than an ambient apparent temperature.

16. The infrared attenuator of claim 10, wherein the infrared absorption is caused by excitation of surface plasmon polaritons.

17. A method comprising attenuating a beam of infrared radiation by emitting the beam onto an infrared attenuator including a prism having a first conductive element at a surface thereof and a second conductive element at a distance from the first conductive element and adjusting the distance to cause infrared absorption by the first conductive element and second conductive element.

18. The method of claim 17, wherein the first conductive element is on a surface of the prism.

19. The method of claim 17, wherein the first conductive element is a semiconductor and the second conductive element is a conventional metal.

20. The method of claim 17, wherein the first conductive element is at least partially transparent to the infrared radiation.

21. The method of claim 17, wherein the infrared attenuator has its maximum reflectivity when the distance is at a minimum thereof.

22. The method of claim 17, further comprising generating an infrared scene.

23. The method of claim 17, wherein the first conductive element is composed of at least one electrically conductive material having a permittivity whose real part is negative at the wavelength of the infrared radiation incident on the prism and is at least partially transparent at the infrared radiation incident on the prism.

24. The method of claim 17, wherein the infrared attenuator has a variable apparent temperature that extends to an order of magnitude higher than an ambient apparent temperature.

25. The method of claim 17, wherein the infrared absorption is caused by excitation of surface plasmon polaritons.
